(19) United States
(12) Patent Application Publication
(10) Pub. No.: US 2006/0257597 A1
(43) Pub. Date: Nov. 16, 2006

(54) System and method for drying reinforcing fiber and making molding compounds and resulting products

(76) Inventor: Klaus Friedrich Gleich, Highlands Ranch, CO (US)

Correspondence Address: JOHNS MANVILLE, 10100 WEST UTE AVENUE, LITTLETON, CO, 80127, US

(21) Appl. No.: 11/434,943

(22) Filed: May 16, 2006

Related U.S. Application Data
(63) Continuation-in-part of application No. 10/939,015, filed on Sep. 11, 2004.

(51) Int. Cl. B31B 45/00

(52) U.S. Cl. 428/34.1

(57) ABSTRACT

Systems and methods are disclosed for making a moldable polymer mixture and molded composite products containing reinforcing fibers that were shipped wet, having a moisture content above about 1.0 wt. % and then are dried just before being added to a mixer, plasticator or compounder. The systems and methods produce a compound that when molded produces a molded product having superior properties to conventionally made compounds. Another method uses a drum type dryer and IR heating to dry the fibers in the fiber manufacturer's plant.

This invention includes a system and method for drying reinforcing fiber and/or to achieve better physical properties in composites containing the reinforcing fiber. This application is a continuation-in-part of U.S. patent application Ser. No. 10/939,015 filed Sep. 10, 2004.

Chopped strand reinforced products such as chopped strand for thermoplastics, usually comprising many glass fibers but also carbon, ceramic or polymer fibers, alone or in combination, are typically made from pellets, or other form, of one or a mixture of polymers having dispersed fibers therein. These pellets, etc., are typically made by feeding dry bundles of fibers containing up to several thousand fibers, typically having a length of about 3 mm to about 6 or 7 mm or even up to about 13 mm, into a compounding or extruding machine along with one or more polymers and heating with high shear mixing to plasticize the polymer(s) and disperse the fibers therein. To achieve good feeding characteristics in the dry fiber bundles, important to the users, a substantial amount of film former or binding agent is used in the chemical sizing coated on each fiber to prevent filamentation during storage, shipment and handling. Filamentation is the breaking down of the bundles resulting in excessive small bundles and individual fibers in the product, the presence of which causes bridging in the feeding bin cones, and other fiber handling equipment resulting costly scrap and downtime.

Fiber products used to make FRP have a sizing coating on the fibers. These sizings are known and normally contain a coupling agent such as one or more silanes, one or more lubricants and one or more film formers or binders, and can contain other ingredients such as dispersants, fillers, stabilizers and others. The sizings are normally applied as an aqueous slurry, solution or emulsion, but liquids other than water are sometimes used including a solvent for at least one of the sizing ingredients. The higher amount of bonding agent(s) used in the sizing on the fibers results in stronger fiber to fiber bonding in the bundles. This is good for fiber handling characteristics, but not good for later processing and final product characteristics. Once in the compounder and in contact with the polymer(s) it is usually desirable that the bundles separate into individual fibers and that the fibers disperse thoroughly in the polymer(s). The time and amount of mixing action to accomplish this has a practical limit, and because of the bond strength between the fibers, very high shear mixing is required to achieve a suitable degree of filamentation, fiber dispersion and wet out (coating of the fibers with the polymer or polymer mixture). This very high shear damages the surface and breaks the fibers, and also falls short of complete fiber dispersion. As a result, the reinforced plastic parts produced do not reach the potential in surface characteristics and physical properties. Most product and process development work in this area is aimed at addressing these problems and opportunities.

Potential cost reduction opportunities also exist in the chopped fiber bundle manufacturing processes. The fiber bundles are made by pulling fibers from a plurality of fiberizers while the material is in a molten or plastic state, cooling the fibers, coating the fibers with water and the chemical sizing containing one or more binding agents, gathering the fibers into strands, chopping the strands into segments of desired lengths and drying the wet chopped strands in a vibrating flatbed oven and sorting the resultant dry bundles to remove undesirable small bundles and individual fibers, lumps and fuzz clumps, a significant amount of scrap. A typical process can be seen in U.S. Pat. No. 3,996,032. These types of processes produce chopped strand bundles having a wide range of diameters and containing a wide range of numbers of fibers, e.g. from just a few fibers to 4000 or more fibers per segment. The binding agents in the sizing are expensive and the significant amount of undesirable material removed during and after drying the bundles is costly scrap. Many dry chopped strand products have been produced with the above-described processes and used in making fiber reinforced products of a wide variety.

It is known that using longer fibers in polymers, polymer mixtures and polymer precursor mixtures produces superior properties in the molded parts and many processes have been developed to address the added problem of dispersing much longer fibers, e.g. up to at least 38 mm long fibers in the polymer or polymer mixture. However, less than the desired degree of enhanced product performance has been achieved when adding the long fibers in the traditional up-front location of the plasticizer, due to the high shear resulting in the shortening of the fibers and less than the desired degree of dispersion of the long fibers has been achieved when adding the long fibers after the high shear section of the plasticizer. This has been addressed by using two or more screw plasticizers, but these take up more space and are more expensive to purchase and operate. Some of these systems and methods are disclosed in U.S. Pat. Nos. 6,676,874, 6,468,464, 6,364,518, and 6,186,769 and in EP 416,859, EP 751,828 and WO 01/54877. These limitations are slowing the rate of growth of long fiber reinforced polymer products market share in the competition with products made of metals and other short fiber materials.

### SUMMARY OF THE INVENTION

The present invention is based on the discovery that if the fibers are kept wet and then dried, or nearly dried, just before adding to the compounder, superior properties are achieved in the molded fiber reinforced polymer product. The invention includes a system comprising a fiber feeder for feeding wet fiber, a dryer having a rotating chamber and a compounding device like a compounder, mixer, or plasticizer. The wet fiber feeder can also be a metering feeder or a second metering feeder can receive the dry or near dry fibers and then meter them into the compounding device. The invention also includes a method for making moldable mixtures using this system, and molded product made from the mixtures made by the process. The moldable mixtures comprise at least one type of reinforcing fiber and at least one thermoplastic or thermosetting polymer or polymer precursor, the mixtures being suitable for forming FRP and LFRP products.

In the method, wet fibers, having lengths in the range of about 3 mm to about 100 mm, more typically about 6 mm to about 100 mm and most typically about 12 mm to about 50 mm, usually in the form of bundles and/or pellets or agglomerates containing these fibers, are fed into a rotating chamber of a dryer and then on into the compounding device. Typically the dry or near dry fiber is fed into the compounding device downstream of a high shear zone and into at least one polymer, polymer mixture or at least one polymer precursor that is in a hot fluid or plastic state and optionally mixed with ingredients other than the fiber. The method comprises feeding long fibers into the system to make a moldable material for making FRP and LFRP products.

The invention also includes molding compounds made by the novel method and molded FRP and LFRP parts made from compounds made by the methods and systems described above, the molded parts having better properties than parts made by using fibers that were dried at the fiber making factory.

By wet fibers is meant that the water, solvent or other liquid medium used to make the reinforcing fiber product is not removed or not totally removed until after the wet fiber is removed from a shipping container or package in the compounder's facility or in the FRP or LFRP manufacturers facility where a reinforced polymer compounding system or polymer reinforced product manufacturing system is located. By solvent is meant a non-aqueous solvent for one or more of the sizing ingredients on the surface of the fiber. By not removed or not totally removed is meant that the fiber product contains at least about 0.5 wt. percent, more typically at least about 2 wt. percent, and most typically at least about 5 weight percent of water, solvent or processing liquid. Liquid, most often water, contents of about 8 to about 20 wt. percent or more, more typically about 10 to about 16 and most typically about 12 to about 18 wt. percent are starting moisture contents of the reinforcing fibers in the present invention. The wet fibers can come from the manufacturer as wet fibers, or can come in as wet roving product and be chopped into long fibers just prior to being put into the fiber dryer. The latter equipment for chopping roving at the dryer site is known, e.g. see EP 416,859.

The present invention is applicable to all types of size compositions and wet reinforcing fiber products or without a size coating other than a liquid. The present invention permits the use of fibers in which the size coating contains very little or no film formers or binders, greatly expediting and improving fiber dispersion rate and degree of dispersion.

The fiber feeder for feeding the long fibers into the chamber can have a heater for preheating the fibers while on a vibrating or belt conveyor, but most typically is a tumbling dryer like a Kreyenborg™ Infra Red heated dryer. This drum type dryer rotates, but the material generally slides along, with slight tumbling, a path defined by as a spiral path along the interior of the drum and between one or more spiral walls extending at least one inch, normally at least two inches and most typically at least 3 inches into the chamber from the interior of the drum. A fluid bed conveyor or any type of conveyor, including vibrating conveyor dryers, can be used ahead of the tumbling dryer to preheat the fiber and do some or all of the drying, and the air for heating and conveying the fibers can be heated to preheat the fibers. In the most typical embodiment the final drying in the plastic processing plant takes place in a dryer having a rotating chamber. Most typically the drying chamber has on its interior surface a raised spiral shaped wall extending toward the axis of the chamber at least 1 inch and more typically at least 2 inches and most typically at least 3-4 inches or more. This spiral wall guides the flow of fiber through the dryer. The fiber tumbles slightly allowing the heat to penetrate the mass of fiber flow. Most typically the heat source is a radiant heating panel that radiates heat to the flowing mass of fiber. The fiber need not be dried completely according to the present invention, but should have a moisture content below about 2 wt. percent.

This method of the invention can be used with many types of plastic processing equipment and systems including injection molding equipment, extrusion equipment, blow molding equipment, compression molding equipment including a shot pot/accumulator system, reciprocating screw systems as well as fixed screw systems, plasticators, compounding extruders, compounding mixers and sheet molding compound systems. For processing polymer or polymer precursor or a polymer mixture that is moisture sensitive, it is advisable to vent the volatiles as soon as possible in the second zone of the chamber or dry the fibers just before entry into a barrel or chamber of the plasticator, mixer or compounder. Although the system includes plasticators, mixers and compounders, for purposes of describing the invention, the term plasticator will be used for simplicity.

All kinds of thermoplastic polymers and polymer precursors and mixtures thereof used in FRP systems can be used in the methods of the invention as well as at least most of the thermoset polymers used in sheet molding compounds (SMC) and bulk molding compounds (BMC). These include polyolefins like polypropylene and polyethylene, polyamides, polyesters like polybutylene terephthalate and polyethylene terephthalate, polycarbonates, acetals, styrenics like SMA, ABS, SAN, PAN and PPO, thermoplastic urethanes, liquid crystal polymers, polyimidazole, polyether sulfone, polyphenelene sulfide and others including thermoplastic precursors, reactive thermoplastics. The thermoset polymers or thermoset polymer precursors include unsaturated polyester, vinyl ester, phenolic and epoxy resins.

The invention also includes the above methods and products in which particles of recycle FRP containing long or short fibers are fed into the compounder, mixer or plasticator with or without the dry and/or wet long fiber described above, or further upstream with the polymer or polymer precursor. When the recycle or reclaim is added with the polymer or polymer precursor, the recycle fibers will be shortened, especially in the first zone, but will still act as a reinforcing filler. However, recycle or reclaim can be fed downstream before, with or after the addition of the long reinforcing fibers and doing this will reduce further damage to the recycle or reclaim fibers. In all of the methods of the invention, the fibers are fed into the system in a low density concentration by feeding the fibers with a wide vibrating belt or moving belt or other similar conventional feeder.

Another modification of the invention includes improved methods of making dry or partially dry chopped reinforcing fiber products comprising drawing molten material into fibers, coating the fibers with an aqueous mixture containing at least one silane and/or at least one lubricant, gathering the fibers into strands, chopping the strands of fibers and drying or partially drying the fibers, the improvement comprising drying or partially drying the fibers in a rotating dryer and using radiant heat to heat up the wet fiber and to remove at least most of the moisture. Normally, the molten material will be glass or at least one polymer. The dryer will also most typically have a spiral wall extending at least one inch, usually at least 2 inches and more typically at least about 3 inches into the drying chamber. The most typical dryer of this type is the drum type, IR dryer, manufactured by Kreyenborg GmbH of Munster, Germany, and described earlier. Further modifications of this invention include adding a rotary sorter section onto the drum dryer to remove at least the oversize clumps of fiber that may have formed upstream and that do not disperse well in later plastic processing equipment. It is also desired to have a fines screen in the rotary screen to remove any undesirable fines from the fiber product before packaging.

When the word “about” is used herein it is meant that the amount or condition it modifies can vary some beyond that so long as the advantages of the invention are realized. Practically, there is rarely the time or resources available to very precisely determine the limits of all the parameters of ones invention because to do would require an effort far greater than can be justified at the time the invention is being developed to a commercial reality. The skilled artisan understands this and expects that the disclosed results of the invention might extend, at least somewhat, beyond one or more of the limits disclosed. Later, having the benefit of the inventors disclosure and understanding the inventive concept and embodiments disclosed including the best mode known to the inventor, the inventor and others can, without inventive effort, explore beyond the limits disclosed to determine if the invention is realized beyond those limits and, when embodiments are found having no further unexpected characteristics, the limits of those embodiments are within the meaning of the term about as used herein. It is not difficult for the artisan or others to determine whether such an embodiment is either as expected or, because of either a break in the continuity of results or one or more features that are significantly better than those reported by the inventor, is surprising and thus an unobvious teaching leading to a further advance in the art.

### DETAILED DESCRIPTION OF PREFERRED EMBODIMENTS

Typically, the wet chopped strand or wet chopped fiber used in the invention will be at least 3 mm long and as long as at least about 100 mm, with a typical range being between about 3-6 mm for short fibers and about 6 mm and about 50 mm, most typical being in the range of about 8 mm to about 40 mm for long fibers. The majority of the fibers in the chopped strands typically have diameters of from about 6 microns to about 30 microns, preferably from about 9 to about 23 microns, but other diameters are suitable for some applications as is known. Normally most of the fibers will be in a narrow fiber diameter range and length, because this is how most chopped strand products on the market are made, but this is not necessary as the lengths and fiber diameters can be tailored to meet a specific application.

The moisture or solvent content of the wet chopped fiber strand coming from the chopper varies from about 8 wt. percent to about 20 wt. percent, or more. The chopped fiber can lose about 2-3 percent in the handling and packaging system at the fiber manufacturing plant including through the conventional feeding equipment feeding the dryer at the customers' plants. Preferably the moisture content is within the range of about 3-18 percent, and most preferably in the range of about 6 to about 17 percent as the fiber enters the dryer.

Many types of fiber can be used in the present invention including all kinds of glass fibers including E, S, C, R, and T, all kinds of ceramic fibers, all types of carbon and graphite fibers, all types of natural mineral fibers, natural organic fibers, polymer fibers and all types of metal fibers. Glass fibers, carbon fibers, natural fibers and polymer fibers are most commonly used in FRP products and are preferred in this invention. Chopped glass fibers, chopped glass fiber strands and glass fiber rovings conventionally used in FRP processes, except used herein were shipped wet and then are dried, or chopped and dried, just before addition to a mixer, plasticator, extruder, etc. and mixied with a polymer, polymer mixture or polymer precursor in the invention.

Wet chopped glass fibers and wet chopped glass fiber strand products are available and are used in wet process such as wet mat machines used to make non-woven fibrous mats, stampable sheet FRP products, and gypsum wall board products. The sizing compositions on some of these products contain only one or two ingredients, e.g. U.S. Pat. No. 6,294,253. These wet products are usable in the invention as are other wet fiber products having a sizing containing one or more ingredients or different ingredients. It is preferred that the size on the fibers of both the chopped fiber products and roving products have at least one coupling agent, such as a silane, and/or at least one lubricant therein. The wet fiber products are usually shipped in sealed plastic bags inside a container such as a cardboard box. Conventional dried fiber products are normally stored and shipped in containers that alone would be unsuitable for shipping wet fiber. It is not critical to the products used in the present invention if they dry out some during shipment and storage, but it is necessary to protect the container from liquid in the fiber products that would cause the packaging material from loosing strength and failing due to absorption of moisture or solvent from the wet fiber. That can be done with plastic bags or plastic, wood or metal containers.

The wet roving is made in a conventional manner except the drying step, used to remove the liquid such as water or a solvent and to cure the film forming binder in the sizing on the fiber, is omitted, or greatly reduced, to leave at least about 3 percent, preferably at least about 5 percent liquid in the roving product. It is preferred to package and even ship the roving rolls, or roving packages with the same, or close to the same liquid content as they contain when they are removed from the roving winder on which the roving roll or roving package is formed in the fiber forming room. This liquid content, typically moisture content, is normally at least 3 wt. percent, typically at least 6 wt. percent and most typically at least 8 wt. percent and can be up to about 20 wt. percent. Also, the film former or binder ingredient(s) in the sizing composition coated on the fibers can be reduced or eliminated entirely. Products made on known roving processes can be used, such as those disclosed in U.S. Pat. Nos. 5,055,119, 5,605,757, 5,957,402, 6,349,896, 6,425,545, 6,568,623, and 6,780,468, the disclosures of which are included herein by reference. The wet roving products used in the present invention can be packaged in plastic bags, plastic film, stretch wrap, shrink wrap or plastic containers. It is not necessary to completely cover the tops or the bottoms of the roving packages with the plastic packaging materials, but only enough to contain the roving rolls or roving packages and to prevent failure of the cardboard slip sheets or trays normally used to ship roving packages. It does not hurt the wet roving of the present invention to partially or even completely dry during storage, shipment or both. When wet roving products are used in the invention the system contains a roving chopper, which are well known, and a stand for holding multiple roving packages. A fiber strand is pulled from each roving package by the roving chopper. The chopped rovings are fed into the dryer, the speed of the roving chopper and the number of strands entering the chopper act to meter the proper rate of reinforcing fibers into the dryer and then into a mixer, compounding machine. The remainder of the method of mixing the dry, hot fibers with the hot polymer(s) or polymer precursor(s) mixture(s) is disclosed in U.S. patent application Ser. No. 10/939,015 filed Sep. 10, 2004, the entire disclosure of which is hereby incorporated herein by reference.

All kinds of thermoplastic polymers and polymer precursors and mixtures thereof used in FRP systems can be used in the systems and methods of the invention as well as at least most of the thermoset polymers used in sheet molding compounds (SMC) and bulk molding compounds (BMC). These include polyolefins like polypropylene and polyethylene, polyamides, polyesters like polybutylene terephthalate and polyethylene terephthalate, polycarbonates, acetals, styrenics like SMA, ABS, SAN, PAN and PPO, thermoplastic urethanes, liquid crystal polymers, polyimidazole, polyether sulfone, polyphenelene sulfide and others including thermoplastic precursors, reactive thermoplastics. The systems and methods of the invention can also be used with thermosetting polymers or polymer systems in which case the barrel or chamber of the compounding machine need not be heated, or not heated to as high a temperature, to avoid premature cross linking of the polymer(s). The thermoset polymers or thermoset polymer precursors include unsaturated polyester, vinyl ester, phenolic and epoxy resins.

Molded products made by drying the reinforcing fiber just before inserting the dry, hot fiber into the mixer or compounder have superior properties to molded products made using conventional 718 dry reinforcing glass fiber available from Johns Manville of Denver, Colo., as shown by the test data in the Table below. The mixing and molding procedures were the same for both examples with only the moisture content of the starting reinforcing fiber being different.

TABLE

| | Un-notched | Std. | | Flex | Flex Mod |
|---|---|---|---|---|---|
| Example | Izod | Dev. | Tensile(psi) | (psi) | (Mpa) |
| Normal 718 | 4.39 | 0.535 | 18,350 | 23,268 | 0.895 |
| Wet 718 | 5.69 | 0.551 | 19,700 | 25,617 | 0.989 |
| Dried* | | | | | |

*Dried at the compounder's location just before adding to the compounding machine and added still hot.

As can be seen from the data, when the 718 fiber product was shipped wet (with about 10-13 wt. % moisture), unexpected higher physical properties were obtained in the molded products compared with molded products made from JM's conventional 718 product that is dried at the reinforcing fiber manufacturer's plant to a moisture content below about 0.08 wt. % before packaging and shipping in the conventional manner.

In practicing the invention it is most typical to use a rotary drum drier to dry the wet reinforcing fiber, either in the fiber manufacturing plant or in the plastic processing plant just prior to adding the hot reinforcing fiber to the plastic processing equipment for dispersing in hot polymers or polymer precursor mixtures. Typical drum dryers are those sold by Kreyenborg GmbH of Munster, Germany, as Infra Red heated drum dryers and those shown in U.S. Pat. No. 6,035,546, the disclosure being incorporated herein by reference. The most typical of these dryers used in this invention is those having a spiral path for the material being dried which path lays against the interior surface of the drum and is delineated by a spiral wall attached to the interior surface of the drum, the spiral wall extending away from the drum at least 1-4 inches. This type of dryer provides a gentle stirring of the wet fiber while exposing them to radiant heat to remove the moisture from the fibers. As a modification of the invention, these rotary dryers are also used to dry, or nearly dry, wet reinforcing fibers in the reinforcing fiber manufacturer's plant and systems.

In practicing the invention it is often desirable to sort the dry or nearly dry, low moisture content, fibers as they exit the rotary drum dryer to remove at least any clumps of fiber that have formed to that point, and also optionally to remove fines including broken fibers and sometimes individual fibers or strands containing only a few fibers, this sorting being conventional in systems of making dry reinforcing fibers. Conventional sorters can be used including rotary screens available from McLanahan Corp. of Hollidaysburg, Pa., and TEMA Isenmann, Inc. of Lexington, Ky. It is most desirable to attach one or more rotary screens onto the exit end of the rotary dryer to conduct the sorting in a continuation of the rotary drying motion and without having to have additional motor(s) or drive(s). These methods eject the sorted hot fiber, dry or partially dry, either into a plastic processing system or into conventional fiber packaging equipment.

Different embodiments employing the concept and teachings of the invention will be apparent and obvious to those of ordinary skill in this art and these embodiments are likewise intended to be within the scope of the claims. The inventor does not intend to abandon any disclosed inventions that are reasonably disclosed but do not appear to be literally claimed below, but rather intends those embodiments to be included in the broad claims either literally or as equivalents to the embodiments that are literally included.

1. A method for preparing reinforcing fiber for mixing with one or more polymers or one or more polymer precursors or mixtures containing one or more polymers, one or more polymer precursors or combinations thereof comprising applying a liquid sizing containing one or more chemicals to the surfaces of fibers, packaging and shipping the resulting fiber product, the improvement comprising;
packaging and shipping the wet fiber product before drying and while the product has a moisture content of at least about 1 wt. %, removing the wet fiber product at the compound manufacturer's plant from its package, drying the fiber product and feeding the dried fiber product into a mixer or compounder.

2. The method of claim 1 wherein the wet fiber product is in a roving form when shipped and is chopped before drying at the compound manufacturer's plant.

3. The method of claim 1 wherein the wet fiber product shipped is chopped fiber or chopped fiber strands.

4. The method of claim 1 wherein the drying takes place in a tumbling dryer.

5. The method of claim 2 wherein the drying takes place in a tumbling dryer.

6. The method of claim 3 wherein the drying takes place in a tumbling dryer.

7. The method of claim 1 wherein the heat for drying comprises radiant heat from an IR heater.

8. The method of claim 2 wherein the heat for drying comprises radiant heat from an IR heater.

9. The method of claim 3 wherein the heat for drying comprises radiant heat from an IR heater.

10. The method of claim 4 wherein the heat for drying comprises radiant heat from an IR heater.

11. The method of claim 5 wherein the heat for drying comprises radiant heat from an IR heater.

12. The method of claim 6 wherein the heat for drying comprises radiant heat from an IR heater.

13. The method of claim 4 wherein the tumbling dryer has an internal spiral wall attached to the shell and extending inwardly at least about 1 inch.

14. The method of claim 5 wherein the tumbling dryer has an internal spiral wall attached to the shell and extending inwardly at least about 1 inch.

15. The method of claim 6 wherein the tumbling dryer has an internal spiral wall attached to the shell and extending inwardly at least about 1 inch.

16. The method of claim 7 wherein the tumbling dryer has an internal spiral wall attached to the shell and extending inwardly at least about 1 inch.

17. The method of claim 1 further comprising feeding hot, dry fiber coming from the dryer into a mixer, plasticator or compounder.

18. The method of claim 2 further comprising feeding hot, dry fiber coming from the dryer into a mixer, plasticator or compounder.

19. The method of claim 3 further comprising feeding hot, dry fiber coming from the dryer into a mixer, plasticator or compounder.

20. The method of claim 4 further comprising feeding hot, dry fiber coming from the dryer into a mixer, plasticizer or compounder.

21. The method of claim 5 further comprising feeding hot, dry fiber coming from the dryer into a mixer, plasticizer or compounder.

22. The method of claim 6 further comprising feeding hot, dry fiber coming from the dryer into a mixer, plasticizer or compounder.

23. The method of claim 8 further comprising feeding hot, dry fiber coming from the dryer into a mixer, plasticizer or compounder.

24. The method of claim 12 further comprising feeding hot, dry fiber coming from the dryer into a mixer, plasticizer or compounder.

25. A system for making a molding compound containing a polymer or polymer precursor comprising a feeder for feeding fiber and a mixer, compounder or plasticator, the improvement comprising;
a feeder for feeding wet fiber or wet fiber strands, the wet fiber or wet fiber strands containing at least about 1 wt. % moisture.

26. The system of claim 25 further comprising a chopper for chopping the wet fiber or the wet fiber strands.

27. The system of claim 25 further comprising a dryer for reducing the moisture content of the wet fiber or wet fiber strands to no more than 1 wt. %.

28. The system of claim 26 further comprising a dryer for reducing the moisture content of wet chopped fiber or wet chopped fiber strands to no more than 1 wt. %.

29. The system of claim 27 wherein the source of heat for the dryer is a radiant heater.

30. The system of claim 28 wherein the source of heat for the dryer is a radiant heater.

31. The system of claim 27 wherein the dryer is a tumbling dryer.

32. The system of claim 28 wherein the dryer is a tumbling dryer.

33. The system of claim 29 wherein the dryer is a tumbling dryer.

34. The system of claim 30 wherein the dryer is a tumbling dryer.

35. The system of claim 27 wherein the dryer contains a spiral shaped wall attached to a shell of the dryer.

36. The system of claim 28 wherein the dryer contains a spiral shaped wall attached to a shell of the dryer.

37. The system of claim 30 wherein the dryer contains a spiral shaped wall attached to a shell of the dryer.

38. The system of claim 32 wherein the dryer contains a spiral shaped wall attached to a shell of the dryer.

39. The system of claim 34 wherein the dryer contains a spiral shaped wall attached to a shell of the dryer.

40. A molding compound produced by the method of claim 1.

41. A molding compound produced by the method of claim 4.

42. A molding compound produced by the method of claim 9.

43. The method of claim 17 further comprising molding the compound into a molded product.

44. A molded product produced by the method of claim 43.

45. A method for preparing chopped reinforcing fiber comprising drawing fibers from a molten material, applying a liquid aqueous sizing containing one or more chemicals to the surfaces of fibers, gathering the wet fibers into a strand, running one or more fiber strands into a chopper to separate the fiber strand(s) into short lengths, drying the chopped fibers and packaging and shipping the resulting fiber product, the improvement comprising;
drying the wet chopped fiber strands in a drum type dryer using infra red radiant heat to heat the fiber to remove the moisture from the chopped fiber strands.

46. The method of claim 45 wherein the molten material is glass.

47. The method of claim 46 wherein the interior of the drum is such as to cause to chopped fiber strands to follow a spiral path laying on the interior surface of the drum.

48. The method of claim 45 wherein the dry fibers coming from the drum type dryer passes into a sorter to remove at least any large clumps of fibers that would not disperse adequately in a later plastic processing system.

49. The method of claim 46 wherein the dry fibers coming from the drum type dryer passes into a sorter to remove at least any large clumps of fibers that would not disperse adequately in a later plastic processing system.

50. The method of claim 47 wherein the dry fibers coming from the drum type dryer passes into a sorter to remove at least any large clumps of fibers that would not disperse adequately in a later plastic processing system.

51. The method of claim 48 wherein the sorter is a rotating sorter integral with the rotating drum dryer.

52. The method of claim 49 wherein the sorter is a rotating sorter integral with the rotating drum dryer.

53. The method of claim 50 wherein the sorter is a rotating sorter integral with the rotating drum dryer.
